(19) United States
(12) Patent Application Publication
(10) Pub. No.: US 2015/0030887 A1
(43) Pub. Date: Jan. 29, 2015

(54) MAGNETIC DEVICES WITH MOLECULAR OVERCOATS

(71) Applicant: SEAGATE TECHNOLOGY LLC, Cupertino, CA (US)

(72) Inventor: John L. Brand, Burnsville, MN (US)

(73) Assignee: SEAGATE TECHNOLOGY LLC, Cupertino, CA (US)

(21) Appl. No.: 13/948,248

(22) Filed: Jul. 23, 2013

(51) Int. Cl. G11B 5/72; B05D 1/02; B05D 1/00; B05D 1/18; G11B 5/84; G11B 5/85

(52) U.S. Cl. CPC G11B 5/72; G11B 5/8408; G11B 5/85; B05D 1/005; B05D 1/18; B05D 1/02
USPC 428/835.7; 428/834; 428/835.6; 427/127

(57) ABSTRACT

A data storage device including a substrate; a magnetic structure deposited on the substrate; and a molecular overcoat deposited on the magnetic structure, the molecular overcoat having a thickness of not greater than about 100 Å.

### BACKGROUND

The heat assisted magnetic recording (HAMR) process can involve an environment that can be extremely corrosive because of the high temperature and exposure to corrosive chemistries. Furthermore, designs using close head-media spacing will experience more rapid wear of any narrow, protruded features such as write poles. Because of the harsh environment and the desire to protect the structures of HAMR heads, for example the near field transducer (NFT) and the write pole for example, there remains a need for different types of overcoats.

### SUMMARY

Disclosed herein are data storage devices including a substrate; a magnetic structure deposited on the substrate; and a molecular overcoat deposited on the magnetic structure, the molecular overcoat having a thickness of not greater than about 100 Å.

Also disclosed are methods of forming a device, the method including forming a magnetic structure on a substrate; and forming a molecular overcoat on the magnetic structure.

Also disclosed are magnetic devices that include a substrate; an energy generating structure; a magnetic structure deposited on the substrate; and a molecular overcoat deposited on the magnetic structure.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an inclusive list.

### BRIEF DESCRIPTION OF THE FIGURES

FIG. 1 is a pictorial representation of a data storage device in the form of a disc drive that can include a recording head constructed in accordance with an aspect of this disclosure.

FIG. 2 is a side elevation view of a recording head constructed in accordance with an aspect of the invention.

FIG. 3 is a schematic depiction of a device, looking from the air bearing surface (ABS).

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific embodiments. It is to be understood that other embodiments are contemplated and may be made without departing from the scope or spirit of the present disclosure. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

“Include,” “including,” or like terms means encompassing but not limited to, that is, including and not exclusive. It should be noted that “top” and “bottom” (or other terms like “upper” and “lower”) are utilized strictly for relative descriptions and do not imply any overall orientation of the article in which the described element is located.

Disclosed herein are devices that include molecular overcoats. Molecular overcoats may provide better thermal stability than previously utilized overcoats. This could be advantageous because some applications may suffer from diminished thermal stability of currently utilized overcoats.

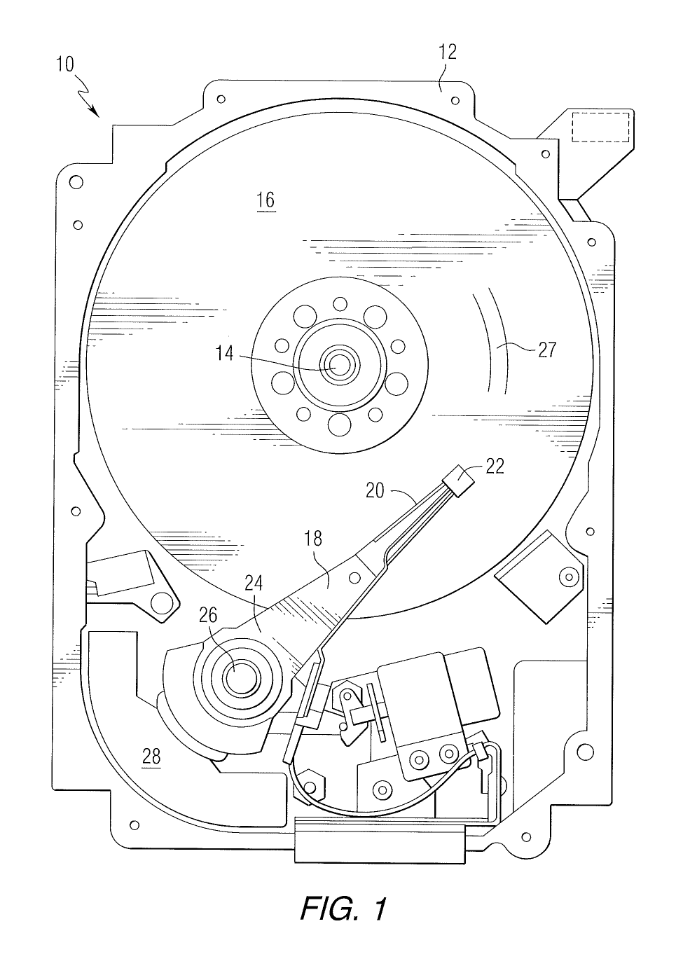

FIG. 1 is a pictorial representation of a data storage device in the form of a disc drive 10. The disc drive 10 includes a housing 12 (with the upper portion removed and the lower portion visible in this view) sized and configured to contain the various components of the disc drive. The disc drive 10 includes a spindle motor 14 for rotating at least one magnetic storage media 16 within the housing. At least one arm 18 is contained within the housing 12, with each arm 18 having a first end 20 with a recording head or slider 22, and a second end 24 pivotally mounted on a shaft by a bearing 26. An actuator motor 28 is located at the arm's second end 24 for pivoting the arm 18 to position the recording head 22 over a desired sector or track 27 of the disc 16. The actuator motor 28 is regulated by a controller, which is not shown in this view and is well-known in the art. The storage media may include, for example, continuous media or bit patterned media.

For heat assisted magnetic recording (HAMR), electromagnetic radiation, for example, visible, infrared or ultraviolet light is directed onto a surface of the data storage media to raise the temperature of a localized area of the media to facilitate switching of the magnetization of the area. Recent designs of HAMR recording heads include a thin film waveguide on a slider to guide light toward the storage media and a near field transducer to focus the light to a spot size smaller than the diffraction limit. While FIG. 1 shows a disc drive, disclosed NFTs can be utilized in other devices that include a near field transducer.

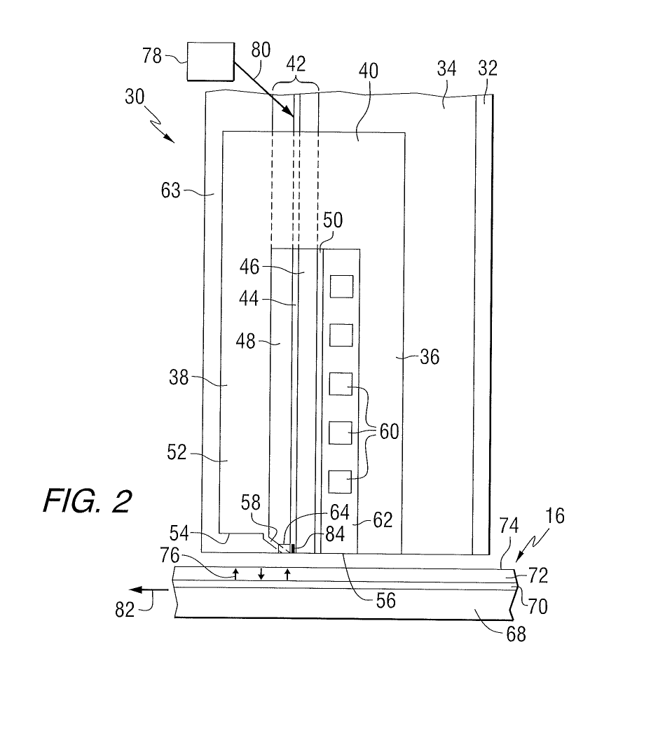

FIG. 2 is a side elevation view of a recording head that may be included in disclosed devices; the recording head is positioned near a storage media. The recording head 30 includes a substrate 32, a base coat 34 on the substrate, a bottom pole 36 on the base coat, and a top pole 38 that is magnetically coupled to the bottom pole through a yoke or pedestal 40. A waveguide 42 is positioned between the top and bottom poles. The waveguide includes a core layer 44 and cladding layers 46 and 48 on opposite sides of the core layer. A mirror 50 can be positioned adjacent to one of the cladding layers. The top pole is a two-piece pole that includes a first portion, or pole body 52, having a first end 54 that is spaced from the air bearing surface 56, and a second portion, or sloped pole piece 58, extending from the first portion and tilted in a direction toward the bottom pole. The second portion is structured to include an end adjacent to the air bearing surface 56 of the recording head, with the end being closer to the waveguide than the first portion of the top pole. A planar coil 60 also extends between the top and bottom poles and around the pedestal. In this example, the top pole serves as a write pole and the bottom pole serves as a return pole.

An insulating material 62 separates the coil turns. In one example, the substrate can be AlTiC, the core layer can be Ta₂O₅, and the cladding layers (and other insulating layers) can be Al₂O₃. A top layer of insulating material 63 can be formed on the top pole. A heat sink 64 is positioned adjacent to the sloped pole piece 58. The heat sink can be comprised of a non-magnetic material, such as for example Au.

As illustrated in FIG. 2, the recording head 30 includes a structure for heating the magnetic storage media 16 proximate to where the write pole 58 applies the magnetic write field H to the storage media 16. In this example, the media 16 includes a substrate 68, a heat sink layer 70, a magnetic recording layer 72, and a protective layer 74. However, other types of media, such as bit patterned media can be used. A magnetic field H produced by current in the coil 60 is used to control the direction of magnetization of bits 76 in the recording layer of the media.

The storage media 16 is positioned adjacent to or under the recording head 30. The waveguide 42 conducts light from a source 78 of electromagnetic radiation, which may be, for example, ultraviolet, infrared, or visible light. The source may be, for example, a laser diode, or other suitable laser light source for directing a light beam 80 toward the waveguide 42. Specific exemplary types of light sources 78 can include, for example laser diodes, light emitting diodes (LEDs), edge emitting laser diodes (EELs), vertical cavity surface emitting lasers (VCSELs), and surface emitting diodes. In some embodiments, the light source can produce energy having a wavelength of 830 nm, for example. Various techniques that are known for coupling the light beam 80 into the waveguide 42 may be used. Once the light beam 80 is coupled into the waveguide 42, the light propagates through the waveguide 42 toward a truncated end of the waveguide 42 that is formed adjacent the air bearing surface (ABS) of the recording head 30. Light exits the end of the waveguide and heats a portion of the media, as the media moves relative to the recording head as shown by arrow 82. Energy delivered by the NFT 84 is the primary means of heating the media. A near-field transducer (NFT) 84 is positioned in or adjacent to the waveguide and at or near the air bearing surface. The design may incorporate a heat sink made of a thermally conductive material integral to, or in direct contact with, the NFT 84, and chosen such that it does not prevent coupling of electromagnetic energy into and out of the NFT 84. The heat sink may be composed of a single structure or multiple connected structures, positioned such that they can transfer heat to other metallic features in the head and/or to the gas flow external to the recording head.

Although the example of FIG. 2 shows a perpendicular magnetic recording head and a perpendicular magnetic storage media, it will be appreciated that the disclosure may also be used in conjunction with other types of recording heads and/or storage media as well. It should also be noted that disclosed devices can also be utilized with magnetic recording devices other than HAMR devices, and therefore devices that do not include NFTs or energy generating structures (light source 78).

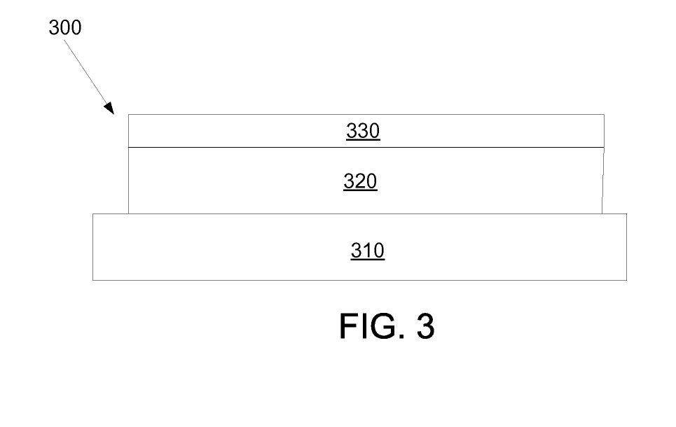

FIG. 3 depicts one example of a device 300 that includes a substrate 310, on or in which a magnetic structure 320 is deposited or formed, and a molecular overcoat 330. The molecular overcoat 330 is deposited on at least a portion of the magnetic structure 320.

Disclosed molecular overcoats include molecules as opposed to atoms (i.e., carbon atoms as in diamond like carbon (DLC)). Molecules are most generally described as electrically neutral groups of atoms that are held together by covalent bonds. In some embodiments, disclosed molecular overcoats include carbon—nitrogen bonds. In some embodiments, disclosed molecular overcoats can include polymers that include carbon—nitrogen bonds. Exemplary polymers can include, for example polyimides, polyamides, polyamideimides, polybenzimidazoles, polyetherimides, polyurethanes, polyetherketones, polyetheretherketones, and polytestrafluorethylenes.

In some embodiments, polyamides can be utilized in molecular overcoats. Polyamides include the functional group (I):

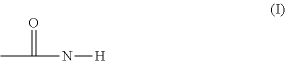

In some embodiments, polyimides can be utilized in molecular overcoats. Polyimides include the functional group (II):

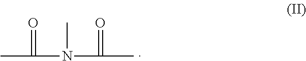

Polyimides, as a group, are known to have excellent thermal stability, i.e., greater than 400° C. Polyimides can be utilized for overcoats in three different ways, by depositing the polymer, by depositing an intermediate of a polyimide, or by depositing starting materials of a polyimide or an intermediate. One method of forming a polyimide is the reaction of a dianhydride and a diamine, such a reaction scheme is exemplified below in Scheme I.

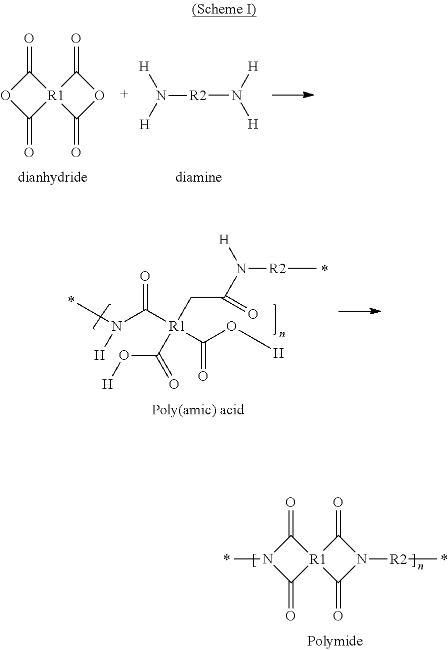

In some embodiments where vacuum, evaporative processes are utilized, the starting materials desirably have measurable vapor pressures at desired process temperatures. Exemplary dianhdyrides that have desirable vapor pressures can include, for example pyromellitic dianhydride, cyclobutane-tetracarboxylic dianhydride, cyclopentane-tetracarboxylic dianhydride, bis(dicarboxyphenyl)hexafluoropropane dianhydride, ethylene tetracarboxylic dianhydride, trimellitic anhydride, tetrafluorophthalic anhydride, and phthalic anhydride. Ethylene tetracarboxylic dianhydride may have drawbacks in manufacturing processes because of its relative instability. Compounds like trimellitic anhydride, tetrafluorophthalic anhydride and phthalic anhydride may be useful in situations where the polymer is desired to be limited to a trimer. Exemplary diamines that have desirable vapor pressures can include, for example ortho-, meta-, or para-phenylene diamine, ortho-, meta-, or para-xylene diamine, oxydiphenylene diamine, aminobenzylamines, bis(trifluoromethyl) biphenyldiamine, tetrafluoro phenylene diamine, and bis(aminomethyl)-cyclohexanes.

An exemplary polyimide is KAPTON® from DuPont. The structure of KAPTON® is seen in formula (III) below:

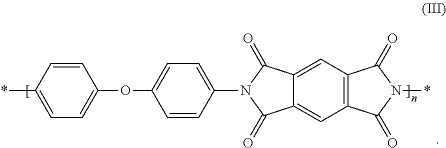

KAPTON® is formed from pyromellitic dianhydride (PMDA) and oxydiphenylene diamine (ODA), as shown below in Scheme II.

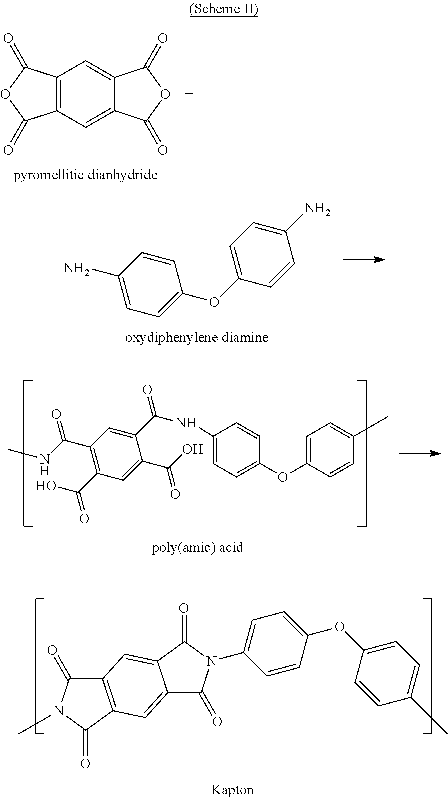

In some embodiments, molecular overcoats can be made using precursor materials such as trimellitic anhydride, trifluoro-trimellitic anhydride, bis(dicarboxyphenyl)hexafluoropropane dianhydride, phthalic anhydride, tetrafluorophthalic anhydride, or combinations thereof; and phenylene diamine, xylene diamine, oxydiphenylene diamine, aminobenzylamines, bis(trifluoromethyl)biphenyldiamines, tetrafluoro phenylene diamine, and bis(aminomethyl)-cyclohexanes, or combinations thereof, for example.

In one exemplary embodiment, tetrafluoro phthalic anhydride and oxydiphenylene diamine can be utilized, as seen in Scheme III below.

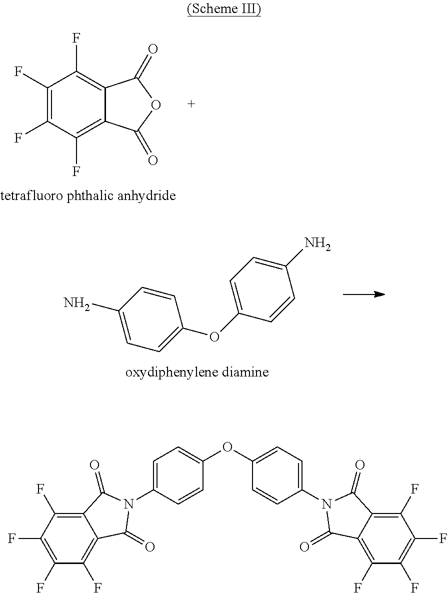

In another exemplary embodiment, tetrafluoro phthalic anhydride and tetrafluoro phenylene diamine can be utilized, as seen in Scheme IV below.

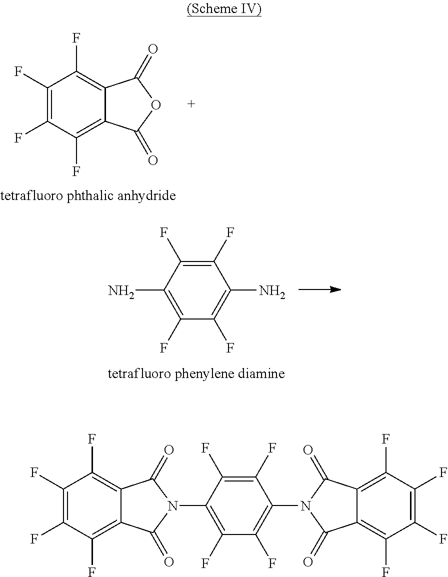

Molecular overcoats disclosed herein can have thicknesses (average) that are not greater than 100 Å. In some embodiments, not greater than 50 Å. In some embodiments, not greater than 20 Å. In some embodiments, from 8 Å to 20 Å. The thickness of a molecular overcoat can be measured using known techniques, including, for example Fourier transform infrared (FTIR) spectroscopy, X-ray photoelectron spectroscopy (XPS), and ultraviolet-visible (UV-Vis) spectroscopy.

Molecular overcoats can be detected and identified, once deposited on an article using various techniques, including, for example spectroscopic techniques. Polyimides, for example have unique spectral features in infrared spectroscopy. Therefore, Fourier transform infrared (FTIR) spectroscopy, Raman spectroscopy, or atomic force microscopy—Raman (AFM-Raman) spectroscopy, for example could be utilized to identify a molecular overcoat containing polyimide. Alternatively, time of flight—secondary ion mass spectroscopy (TOF-SIMS) could also be utilized to detect fragments of polyimides. Also, any elemental surface analytical tool could detect significantly more nitrogen and oxygen in a polyimide (for example) containing film in comparison to a diamond like carbon (DLC) containing film.

There are various processes that could be utilized to deposit materials for molecular overcoats on articles. Generally, such processes can include steps of forming a magnetic structure on or in a substrate. It should be noted that this step can be carried out immediately subsequent to a next step, as part of another process, or even by another user/manufacturer.

The next step is to form a molecular overcoat on the magnetic structures. Forming a molecular overcoat can include depositing a polymeric material and/or can include depositing a precursor to a polymeric material and then at least partially polymerizing the deposited material. Materials deposited that will be polymerized to form a polymeric material can be referred to as precursors. Precursors can include other polymer materials or materials that can form polymers.

Materials, whether polymeric or otherwise can be deposited on the magnetic structures using known methods. Exemplary methods that can be utilized can include, for example spin- or dip-coating processes; vacuum processes; and others.

Spin coating processes generally utilize a mixture containing the components to be deposited and one or more solvent(s). The deposited material could be a precursor to form the desired polymer (in such cases where the precursors could be mixed and coated without reacting), an intermediate polymer (for example a poly(amic) acid in the case of the deposition of a polyimide) or the final polymer (for example a polyimide). Dip coating processes, which are already utilized to deposit thin films of lubricants onto magnetic media could be easily adapted to form a molecular overcoat. In some embodiments, such processes could either coat an intermediate polymer (for example a poly(amic) acid in the case of the deposition of a polyimide) or the final polymer (for example a polyimide), for example. A dip coating process could utilize a mixture containing 0.1% (by weight) for example of the material to be coated in a suitable solvent(s). The surface to be coated is put into the mixture and removed from the mixture at a desired rate, for example a rate of 1 millimeter (mm)/second (sec). In either spin- or dip-coating processes, an adhesion promoter could be utilized before the molecular overcoat is to be applied. Typically utilized adhesion promoters could be utilized herein, exemplary adhesion promoters could include, for example aminosilanes.

Vacuum processes can include, for example evaporative processes, sputtering processes, or ion beam processes for example. Vacuum processes could separately deposit the precursors (for example dianhydride and diamine in the case of a polyimide molecular overcoat), co-deposit the precursors, deposit several precursor layers, or some combination thereof. Once the precursors were deposited, the coated article could then be treated in order to achieve polymerization. For example, the coated article could be subjected to elevated temperatures, radiation, or electrons.

Vacuum processes could also be utilized to deposit intermediates, for example poly(amic) acid, or the final polymer. Such processes could include bulk extraction and deposition processes such as ion beam processes, sputtering processes, laser ablation processes, and pulsed cathodic arc processes. Plasma based processes would likely not be applicable because they would be too destructive to the bonds in the molecular overcoat materials.

Vacuum processes may be advantageous because a pre-deposition sputter cleaning process could very easily be done before the molecular overcoat is deposited. The pre-deposition sputter cleaning could remove any contaminants and prepare the surface for deposition in the same way an adhesion promoter does.

Other alternative processes (besides spin- and dip-coating, and vacuum processes) could also be utilized to form molecular overcoats. For example, a material for a molecular overcoat could be deposited using printing technology such as ink jet printing technologies Ink jet printing can allow precise placement of the molecular overcoat without resorting to photoresists or other patterning technologies. A mixture containing a relatively low concentration of precursors, intermediates, or polymers in a solvent that would later evaporate could be inkjet printed onto the article of interest. In the case of precursors, the printed coating could then be polymerized to form a molecular overcoat including a polymer. Alternatively, two or more separate ink jet depositions could be done with the same or different materials, such as an adhesion promoter, and/or multi precursors followed by a polymerization process.

Another alternative process would include use of a nebulizer to create an aerosol stream of the materials. A mixture containing the material and a volatile solvent is utilized. The nebulizer creates extremely small aerosol particles. In a vacuum, the stream of aerosol particles are directed towards the surface, thereby achieving nearly 100% deposition of the material. A typical nebulizer can create a median particle size of 1 micrometer (μm) diameter. With a 0.0001% concentration, the fully evaporated aerosol diameter can be 10 nanometers (nm). Depositing a 10 nm aerosol over a 30×30 nm area would result in an average 5 Å thick film, for example. In the case of precursors, the coating could then be polymerized to form a molecular overcoat including a polymer.

Thus, embodiments of magnetic devices including molecular overcoats are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation.

What is claimed is:

1. A data storage device comprising:
a substrate;
a magnetic structure deposited on the substrate; and
a molecular overcoat deposited on the magnetic structure, the molecular overcoat having
a thickness of not greater than about 100 Å.

2. The data storage device according to claim 1, wherein the molecular overcoat comprises carbon-nitrogen bonds.

3. The data storage device according to claim 1, wherein the molecular overcoat comprises polyimides, polyamides, poly(amic) acids, or combinations thereof

4. The data storage device according to claim 1, wherein the molecular overcoat has a thickness from about 8 Å to about 20 Å.

5. The data storage device according to claim 1, wherein the molecular overcoat is formed from a diamine and a dianhydride.

6. The data storage device according to claim 5, wherein the diamine is selected from:
ortho-phenylene diamine, meta-phenylene diamine, para-phenylene diamine, ortho-xylene diamine, meta- xylene diamine, para-xylene diamine, oxydiphenylene diamine, aminobenzylamines, bis(trifluoromethyl)biphenyldiamine, tetrafluoro phenylene diamine, bis(aminomethyl)-cyclohexane, or combinations thereof.

7. The data storage device according to claim 5, wherein the dianhydride is selected from:
pyrometllitic dianhydride, cyclobutane-tetracarboxylic dianhydride, cyclopentane-tetracarboxylic dianhydride, bis(dicarboxyphenyl)hexafluoropropane dianhydride, ethylene tetaracarboxylic dianhydride, or combinations thereof

8. A method of forming a device, the method comprising:
forming a magnetic structure on a substrate; and
forming a molecular overcoat on said magnetic structure.

9. The method of claim 8, wherein the molecular overcoat is formed on the magnetic structure by spin coating or dip coating a composition.

10. The method of claim 9, wherein the composition comprises a polyimide polymer and a solvent.

11. The method of claim 9, wherein the composition comprises a polyimide polymer precursor and a solvent.

12. The method of claim 11, wherein the step of forming a molecular overcoat further comprises polymerizing the polyimide precursor.

13. The method of claim 8, wherein the molecular overcoat is formed by a vacuum deposition process.

14. The method of claim 13, wherein the vacuum deposition deposits an intermediate polymeric material.

15. The method of claim 13, wherein the vacuum deposition deposits one or more polyimide precursors.

16. The method of claim 15, wherein the step of forming a molecular overcoat further comprises polymerizing the one or more polyimide precursor.

17. The method of claim 8, wherein the molecular overcoat is formed by printing a composition comprising a polyimide or a polyimide precursor on the magnetic structure.

18. The method of claim 8, wherein the molecular overcoat is formed by depositing an aerosol comprising a polyimide or polyimide precursor.

19. A magnetic device comprising:
a substrate;
an energy generating structure;
a magnetic structure deposited on the substrate; and
a molecular overcoat deposited on the magnetic structure.

20. The magnetic device according to claim 19, wherein the molecular overcoat is formed from a diamine and a dianhydride, wherein
the diamine is selected from: ortho-phenylene diamine, meta-phenylene diamine, para-phenylene diamine, ortho-xylene diamine, meta-xylene diamine, para-xylene diamine, oxydiphenylene diamine, aminobenzylamines, bis(trifluoromethyl)biphenyldiamine, tetrafluoro phenylene diamine, bis(aminomethyl)-cyclohexane, or combinations thereof; and
the dianhydride is selected from: pyromellitic dianhydride, cyclobutane-tetracarboxylic dianhydride, cyclopentane-tetracarboxylic dianhydride, bis(divarboxyphenyl)hexafluoropropane dianhydride, ethylene tetracarboxylic dianhydride, or combinations thereof.
